(19) United States
(12) Patent Application Publication
(10) Pub. No.: US 2009/0305190 A1
(43) Pub. Date: Dec. 10, 2009

(54) Dental Implant And Process For Its Manufacture

(76) Inventor: Holger Zipprich, Darmstadt (DE)

Correspondence Address: SHERIDAN ROSS PC, 1560 BROADWAY, SUITE 1200, DENVER, CO, 80202, US

(21) Appl. No.: 12/297,570

(22) PCT Filed: Apr. 20, 2007
(86) PCT No.: PCT/EP2007/003480

§ 371 Date: May 22, 2009

(30) Foreign Application Priority Data
Apr. 20, 2006 (DE) 10 2006 018 726.1

(51) Int. Cl. A61C 8/00; A61C 13/01

(52) U.S. Cl. 433/173; 433/199.1

(57) ABSTRACT

A dental implant (1) with a post section (2) that can be implanted in the jaw with a designated mounting component (3) to which a crown can be attached should enable the dental technician to select an especially favorable position for the additional mounted components and should make it simultaneously possible for the handler to take advantage of an indication without the use of auxiliary tools (for example, individual keys). For this purpose, the mounted components are designed, as relates to the invention, in multiple sections, preferably in two sections, whereby a first mounted component (31) with an attached formed contact pin can be firmly inserted into an allocated recess in the post section, and the second mounted section (32) with an attached formed contact pin can be inserted into the recess in the first mounted section, and whereby the attached formed contact pin on the second mounted section and its assigned form are contoured in such a way that the contact pin inserted into the recess can be turned on its longitudinal axis with a twisting angle of at least 3°, more advantageously at least 6°, especially advantageously at least 10°.

The invention relates to a dental implant with a post section that can be implanted into a jaw bone and with a mounting component to which a crown can be attached. It further relates to a method for the manufacture of such a dental implant.

Dental implants are known in many forms. They are usually screwed into the jawbone in the place of a tooth which has been extracted or fallen out in order to hold a prosthetic mounting component or a crown after an osseointegration phase of three to four months. For this purpose, such a dental implant is usually embodied as a suitably shaped metal body and shaped in the manner of a pin and has at its apical end a usually self-cutting screw thread with which the pin is inserted into the appropriately prepared implant bed.

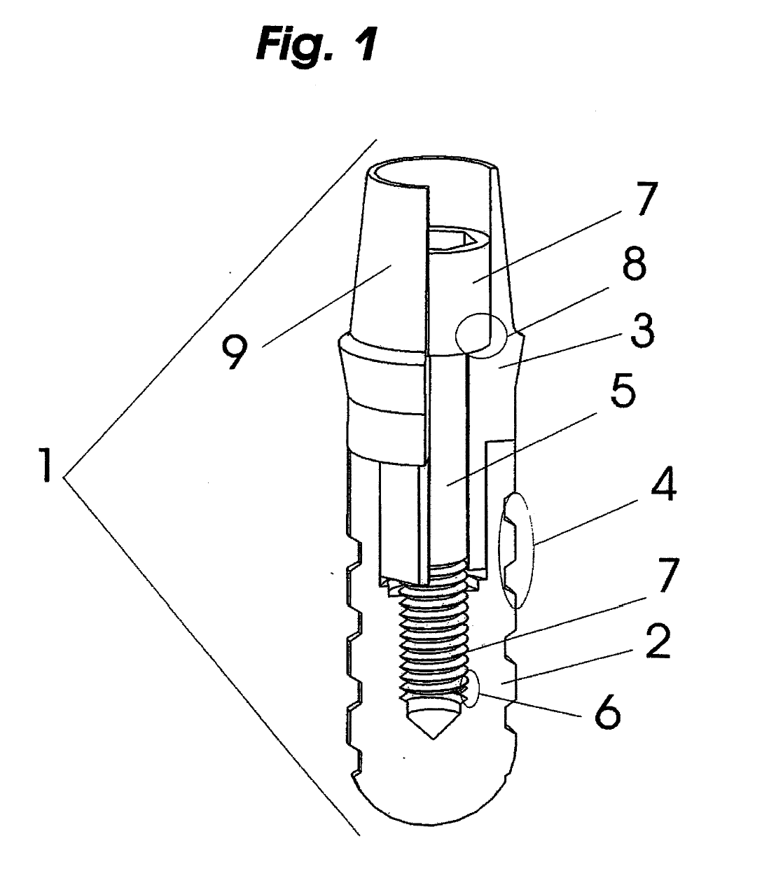

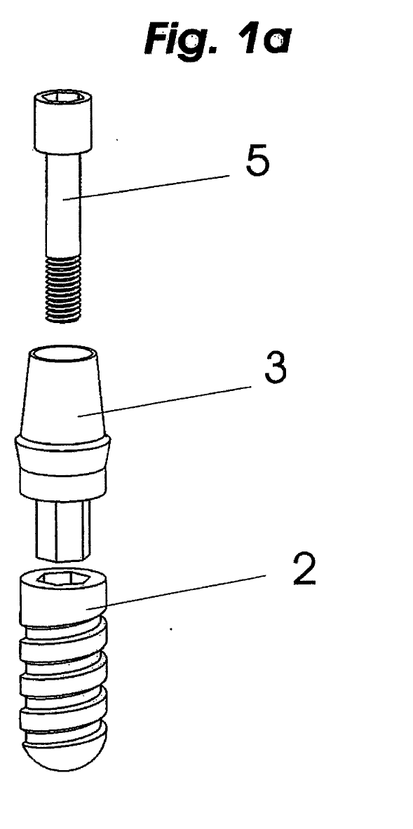

An example of a dental implant of the abovementioned type is shown in FIG. 1 in a partial view and partially in axial cross-section. The two-part dental implant 1 comprises a post section 2 and a mounting component 3. The post section 2 and, likewise, the head or mounting component 3 are composed of metal or a ceramic, particularly of titanium, a titanium alloy, a titanium-containing alloy, a zirconium oxide, aluminum oxide ceramic or a ceramic which contains either zirconium oxide or aluminum oxide. The post section 2 is provided on the outside with a thread 4 which can be embodied as a self-cutting or as a non-self-cutting thread. The slope of the thread can be designed to be uniform or variable. The outer shape of the post section 2 can also be embodied with and without mechanical retention aids. The post section 2 and the mounting component 3 are screwed together via a connection screw 5. The thread of the connection screw 5 is screwed into the internal thread 6 of the post section 2. When the connection screw 5 is screwed in, the screw head 7 of the connection screw 5 presses over the countersink 8 of the mounting component 3 onto the post section 2.

The post section 2 is anchored in an appropriately prepared implant bed of the jawbone. The threaded construction thereby ensures a high primary stability and a uniform transfer of the forces occurring during chewing stress. The mounting component 3 is joined at the upper region 9 with a crown, another prosthetic provision or the like in a known manner. This joint can be embodied as a screwjoint, clamped joint, a self-locking conical joint, underpressure, magnet, ball joint system, cementing, adhesion or the like.

To counteract rotation or twisting between the mounting component 3 and the post section 2 caused by external forces (mostly brought about by chewing stress), either a mechanical indexing is used in the form of a mechanical catch or the surface pressure between mounting component 3 and the post section 2 is selected appropriately. FIG. 1a shows an exploded view of the three elements post section 2, mounting component 3 and connection screw 5 of the dental implant from FIG. 1.

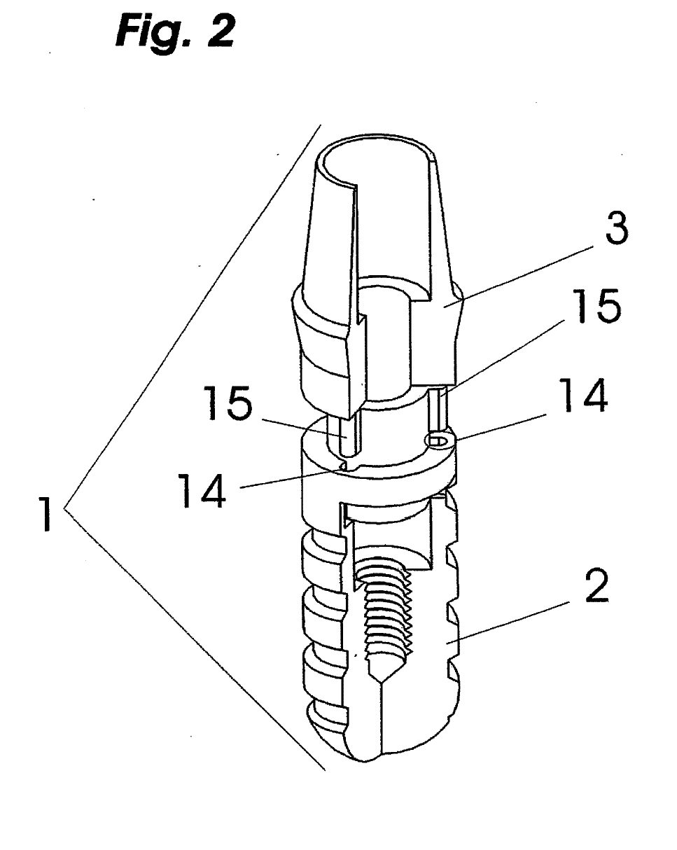

The mechanical catch used to indicate and prevent the rotation of the mounting component 3 on the post section 2 can be embodied in several variations. FIG. 2 shows, for the sake of example, an internal hexagon in the post section 2 and an external hexagon on the mounting component 3. The design as external and internal hexagon can also be embodied the other way around. The number of edges of such an edge system can vary. Moreover, the corners of such edge systems can be provided with a radius. Torx and triple square systems with varying numbers of elements and of varying geometry are known as other designs. What is more, indexing by means of etchings 14 on the post section 2 and protruding elements 15 on the mounting component 3 are known (FIG. 2).

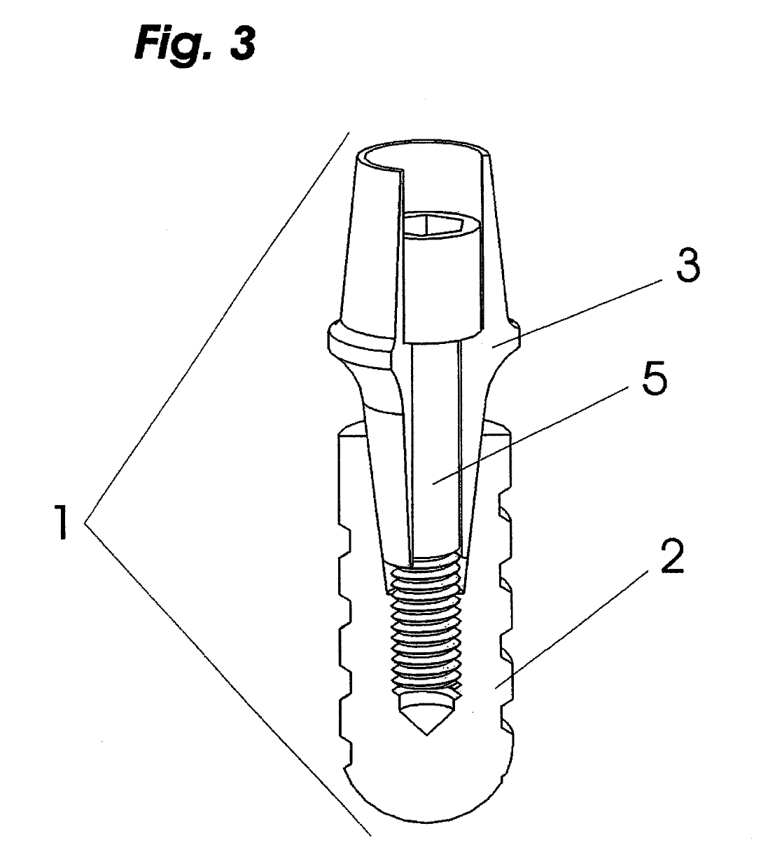

Here, the prevention of the rotation between the post section 2 and the mounting component 3 occurs via the pressing force of the connection screw. In addition or alternatively, the connection between the post section 2 and the mounting component 3 can usually be embodied conically. Particularly, these are designs of the type depicted in FIG. 3, which are embodied as conical stopping mechanisms or conical self-stopping mechanisms based on the cone angle and the surface friction between the conical contact surfaces of the post section 2 and the mounting component 3 upon tightening of the connection screw 5 via the conical contact points between the post section 2 and the mounting component 3.

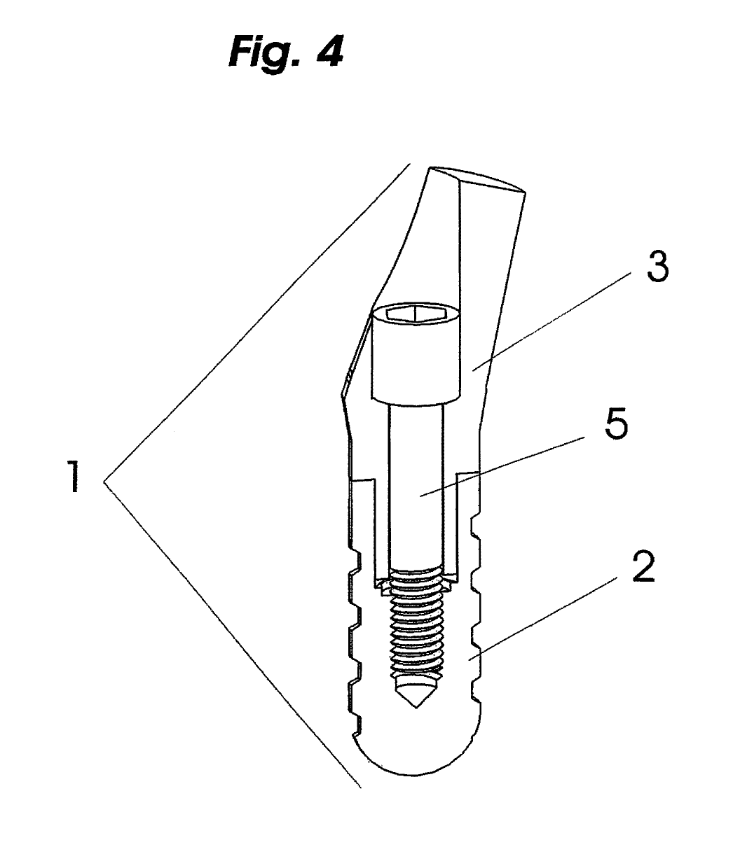

Depending on the point of insertion (front tooth, side tooth region, lower jaw, upper jaw), the bone substance, the remaining teeth, the course and position of the vessels and nerves, it is not always possible for the person providing treatment to drill the bore for the post section/implant in accordance with the axis of the prosthetic provision (crown or the like). Consequently, a straight post section/implant and a straight mounting component are not adequate for the anatomical realities of the patient. In order to counteract this problem, angled mounting components are used (FIG. 4). Angled mounting components are also referred to as angular mounting components. FIG. 4 shows a dental implant 1 with a post section 2, an angled/angular mounting component 3, with the post section 2 and the angular mounting component 3 being screw to each other by means of the connection screw 5.

Usually, this angle lies between 10° and 30°. After insertion, preferably after the osseointegration of the post sections, the spatial and geometric information of the remaining teeth (e.g. antagonists, teeth located mesially and distally to the point of insertion), of the mucous membrane and of the post section/implant or the mounted mounting component must be determined in order to prepare the crown. This spatial and geometric information is necessary in order to produce the crown, bridge or the like in an accurately fitting and anatomically optimized fashion. For this purpose, an impression, preferably of silicon or another dental impression material, is prepared of the oral situation. This impression is preferably filled with plaster or another dental modeling material. This plaster model is a duplicate of the oral situation of the patient. It provides the dentist or the dental technician with information about the position of the other teeth, of the mucous membrane and of the inserted post sections/implants.

In order to improve the transfer of position and geometry of the inserted post sections/implants, special impression posts made of metal and/or plastic are preferably placed and/or screwed on the inserted post section/implant. Subsequently, the impression is prepared in the mouth, preferably with silicon. After the hardening of the impression material, the impression posts either remain on the implant or are removed with the impression upon removal of contact pressure. When the impression is filled, the impression post/mounting post must be placed in the impression and joined with a laboratory implant. With respect to the connection and geometrically in the direction of the impression post/mounting post, this laboratory implant possesses the same or similar geometric shape as the inserted post section/implant. After the filling of the impression with integrated impression post/mounting post and integrated laboratory implant, one obtains a plaster model with cast laboratory implant.

If the implant system used possesses indexing, this was transferred from the patient's mouth to the plaster model. Based on this plaster model, the prosthetic provision of the implant(s) is planned and produced. Here, the rotational position of the mounting component on the implant plays a crucial role. If the implant system used possesses indexing, then the possibilities for the positioning of the mounting component on the laboratory implant are limited. In a hex joint, there are six positional possibilities. In an implant system without indexing, all positions between 0° and 360° can be used. After preparation, a fitting is usually performed in the patient's mouth. During this fitting or the final incorporation of the dental prosthesis, the person providing treatment must incorporate the mounting component(s) and all other prosthetic elements in the patient's mouth in the same position as on the plaster model.

If the inserted implant system is equipped with indexing, the person providing treatment has a limited number of choices for determining the desired position. If there is no indexing in the implant system used, the person providing treatment cannot make use of the advantage of a limited positioning in order to determine the desired position. The person providing treatment must determine the information about the desired rotational position(s) of the mounting component(s) on the implant(s) in another manner. For this, individual keys are usually prepared by the dental technician. The individual key is mounted on the mounting component(s) and placed on the implants in its entirety with the support of the adjacent teeth and/or the adjacent anatomical structure. After the attaching of the mounting components on the implants (screwing, cementing, etc.), the individual key can be removed and the remaining incorporation of the prosthetic components can occur. In conclusion, it can be said that, for the optimal preparation of the prosthetic components, it is advantageous that the dental technician not be restricted by indexing in selecting the rotational positioning when connecting the mounting component and the implant. However, if an individual key has to be prepared, this is associated with effort and costs for the dental technician. Moreover, it is associated with a greater effort for the person providing treatment during incorporation. It is more favorable for the dentist if the number of positional possibilities of the mounting component on the implant is as few as possible. 8-12 possibilities are agreeable; 3-5 possibilities are advantageous, particularly 1-2 positional possibilities.

That is to say, it is optimal for the dental technician to be able to make use of a rotational freedom of motion of (an) angled or non-angled mounting component(s) of 360°, but for the dentist to only have one positional possibility on the post section in the mouth without tools for the incorporation of the single-piece or multiple-piece mounting component.

It is therefore the object of the invention to propose a dental implant of the aforementioned type which permits the dental technician to use all positions between 0° and 360° and makes it possible for the person providing treatment at the same time to make use of the advantages of indexing described above without the use of auxiliary tools (e.g. individual keys). Moreover, a method which is especially suitable for the manufacture of the dental implant is to be proposed.

With respect to the method, this object is achieved according to the invention with the features of claim 1. There, a provision is made that the dental implant has a mounting component which is embodied in at least two parts, with said mounting component joining the post section implanted into the jawbone with the dental prosthesis. As a result of the two-part construction of the mounting component, the fine adjustment of the rotational orientation of the mounting component parts relative to each other can occur, and the final introduction into the mouth region can occur through fixation on the already-implanted post section without degrees of rotational freedom and hence orientationally true.

For this purpose, a contact pin formed on the second mounted section is first inserted into a designated recess in the first mounted section, and the required orientation can be adjusted through appropriate alignment of these components in relation to each other. Subsequently, the second mounted section is fixed to the first, so that the already-adjusted orientation is also preserved for the further processing steps. Subsequently, in a later work step, the entire mounting component is joined, particularly by the dentist, with the post section already implanted into the jawbone, with a contact pin formed on the first mounted section being introduced in a positive manner into a designated recess in the post section. Here, the recess in the post section is preferably embodied such that a prescribed orientation of the mounting component is preserved in the manner of a locking mechanism.

To adjust the degree of rotational freedom or the relative orientation between the first and the second mounted section as needed, the cross sections of the elements provided for this connection, i.e. of the contact pin and the designated recess, can be selected such that a free rotation of the contact pin introduced into the recess is made possible at least over a certain twisting angle. Alternatively, the interplay of these components can be set up such that the contact pin is aligned appropriately prior to introduction into the recess and takes shape upon introduction into the recess, hence fixing the orientation at once. For this purpose, the contact pin can be provided with suitable elements such as, for example, cutting edges or the like which fix it in the selected orientation in the recess.

With respect to the dental implant, the stated object is achieved with the features of claim 2. Advantageous embodiments of the invention are the subject of the subclaims.

As a result of the design of the mounting component in multiple parts, a decoupling of a freely selectable rotation with respect to the final orientation of the longitudinal direction of the mounting region of the mounting component provided for the mounting of the crown or of the dental prosthesis by the dental technician is made possible on the one hand by a directional preset of the once-prefabricated intermediate product for the final mounting of the mounting component by the dentist on the other hand on the post section already implanted in the patient's mouth. While taking full advantage of the resulting rotational freedom between the two mounted sections, the dental technician can therefore align the components under conditions which are optimum for him. Subsequently, the mounted sections are fixed to each other so that the alignment performed by the dental technician is preserved. During the final mounting on the post section in the patient's mouth, which is possible only in one prescribed direction due to the positive adaptation of the contact pin provided there to the designated recess, the dentist can then produce the finished dental implant without noteworthy effort spent on adjustment using the provided alignment.

In particular, the structuring of the mounted sections is intended to make it possible here for the dental technician/dentist to select as many positions as possible (more than 8, if possible, and preferably more than 12), advantageously all positions between 0° and 360°, during the rotational positioning of the mounting component(s) on the implant. At the same time, it is intended that the dentist be able to easily recognize the position predefined by the dental technician of the mounting component or mounting components composed of the mounted sections. This is made possible by the multiply divided, preferably two-part mounting component. The following parameters are important in the structuring of the multiple-part mounting component. The basal (post section-side) primary mounting component possesses indexing in the form of a catch in the direction of the post section. The internal connection of the multiple-part mounting component, i.e. the connection between the primary mounting component and the secondary mounting component, makes a freedom of rotational movement possible. Here, during the selection of the optimal rotational position of the secondary mounting component on the primary mounting component, the secondary mounting component can already have the desired spacing from the primary mounting component or have greater spacing from the primary mounting component.

Optimally, the freedom of rotational movement of the secondary freedom of rotational movement on the primary freedom of rotational movement is not restricted. However, it would be quite helpful for the dental technician to be able to select more than 8, preferably more than 12 and, particularly, more than 16 positions of the secondary mounting component on the primary mounting component.

The functional routine during the incorporation of the dental prosthesis breaks down as follows:

The steps after the insertion of the post section up to the preparation of the model preferably out of plaster remain as described above. Now the dental technician/dentist can select a rotational position of the secondary mounting component on the primary mounting component which is optimal for the prosthetic structuring. Once the dental technician/dentist has found the optimal position of the secondary mounting component on the primary mounting component, then he can fix this position. This means that the remaining prosthetic components can be prepared after the fixing of the individual elements of the multiple-part mounting component without one of the elements of the multi-part mounting component shifting rotationally or translationally to one of the other element[s] of the multiple-part mounting component. As a consequence, the fixation prevents and/or impedes the freedom of rotational and/or translational movement of the individual elements of the multiple-part mounting component with respect to each other. After the preparation of the prosthetic components, the person providing treatment receives the multiple-part and internally fixed mounting component and the other prosthetic components. In the patient's mouth, the person providing treatment is able to refer to the indexing between the post section and the multiple-part mounting component.

With the indexing, it is easy for the person providing treatment to determine the desired rotational position of the multiple-part mounting component and to incorporate the multiple-part mounting component as a whole. This can be done by means of a connection screw, a stopping mechanism (preferably a self-locking conical mechanism), a catch, a notch, a cementing or an adhesion. It is especially advantageous to mount all elements of the multiple-part mounting component and the post section with a common connection screw, which is to say that the connection screw is tensioned the occlusally lying element of the multiple-part mounting component via the screw head or a thread and via a thread in the post section with the post section. Consequently, the remaining elements of the multiple-part mounting component are tensioned between the occlusal element of the multiple-part mounting component and the post section.

The fixation between the primary mounting component and the secondary mounting component can occur with different geometries or different mechanisms and/or methods. In the following, various possibilities for the internal fixation between the primary mounting component and the secondary mounting component are pointed out.
1. Internal fixation based on a rotational and/or translational stopping mechanism. This means that the primary mounting component and the secondary mounting component are tensioned against each other mechanically after positioning and, due to the surface friction between them, can only be separated from each other with greater force or the application of torque. This can be achieved by means of various effects or methods.
   a. The internal connection of the multiple-part mounting component is structured in the form of a conical connection. When the elements of the multiple-part mounting component are fixed, the individual elements are pressed so strongly against each other that self-locking occurs between the elements. That is to say that, after the pressing force is removed, the individual elements can only be separated from each other or their position relative to each other can only be changed with increased force or torque. The application of the pressing force can be achieved with a connection screw, the bodily force of the dental technician/dentist or with an auxiliary device.
   b. The internal connection of the multiple-part mounting component is structured in the form of a parallel-walled connection. This parallel-walled connection can take on different geometries. Here, a round shape has proven to be advantageous. The dimensions of the internal connection are set up as a press fit so that, after the joining of the individual elements, they can only be separated or their position relative to each other can only be changed with an increased force or torque. In order to simplify the rotational positioning the element, which is designed as a matrix, can be heated prior to positioning and/or the element, which is designed as a patrix, can be cooled off in order to make easier positioning possible as a result of thermal expansion and/or contraction. In other words, the matrix is shrunk onto the patrix. Moreover, the rotational position[ing] can occur prior to, after, or simultaneously to the translational joining movement. What is more, both the rotational positioning and the translational joining movement can be carried out with an auxiliary means.
2. Internal fixation based on a rotational and/or translational catch, i.e. on indexing which allows for more than 8, preferably more than 12 and particularly more than 16, positioning possibilities and/or possesses a rotational play of more than 3°, preferably more than 6° and particularly more than 10°.
3. Internal fixation based on a subsequently introduced rotational and/or translational catch, i.e. the subsequent introduction of indexing. Various variations and/or methods are possible for the introduction of the catch.
   a. The primary mounting component and the secondary mounting component cannot be joined without the application of greater force or torque. One or more of the elements of the multiple-part mounting component are equipped with one or more geometric elements which are structured such that, upon reciprocal joining through removal of one or more splints from one or more elements of the multiple-part mounting component, they produce/bring about an indexing in the form of a rotational and/or translational catch. Upon joining, a rotational and/or translational locking effect can additionally occur.
   b. The primary mounting component and the secondary mounting component cannot be joined without the application of greater force or torque. One or more of the elements of the multiple-part mounting component are equipped with one or more geometric elements which are structured such that they, upon reciprocal joining through a plastic deformation of one or more elements of the multiple-part mounting component, form an indexing in the form of a rotational and/or translational catch. Upon joining, a rotational and/or translational locking effect can additionally occur.
   c. In variants 3a and 3b, one of the elements of the multiple-part mounting component can be used by an equally or similarly structured auxiliary part which is specially conceived for the splint-removing or forming process.
   d. In variants 3a and 3b, the splint-removing or formed indexing of one or more elements of the multiple-part mounting component can be carried out in an auxiliary device specially conceived for this.
4. Internal fixation based on screwing. The screw can be designed as a common screw, as a screw with a central bore and/or as a screw with variable slopes.
5. The internal fixation is structured such that the multiple-part mounting component only possesses rotational movability prior to fixation. The translational movability is locked as a result of the construction. This can occur before the delivery from the plant or right before the fixation process. That is to say, the mounted sections can be locked and/or blocked against each other in a first step for translational movabilities before they are locked and/or blocked against each other rotationally upon fixation. This can occur by means of forming, removing and/or applying methods with and/or without auxiliary elements.
6. Internal fixation based on welding.
7. Internal fixation based on soldering.
8. Internal fixation based on adhesion.
9. Internal fixation based on cementing.

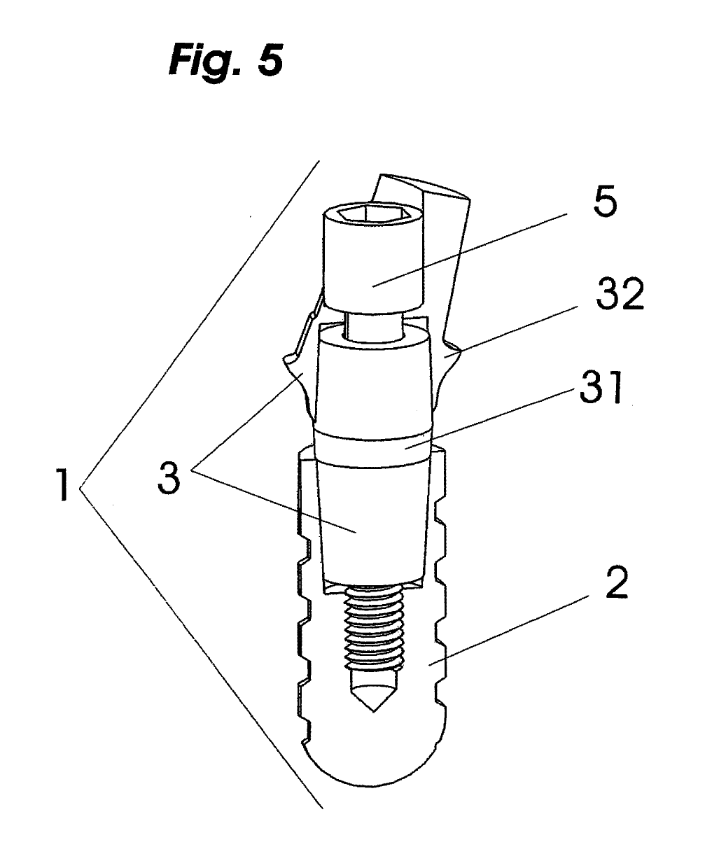

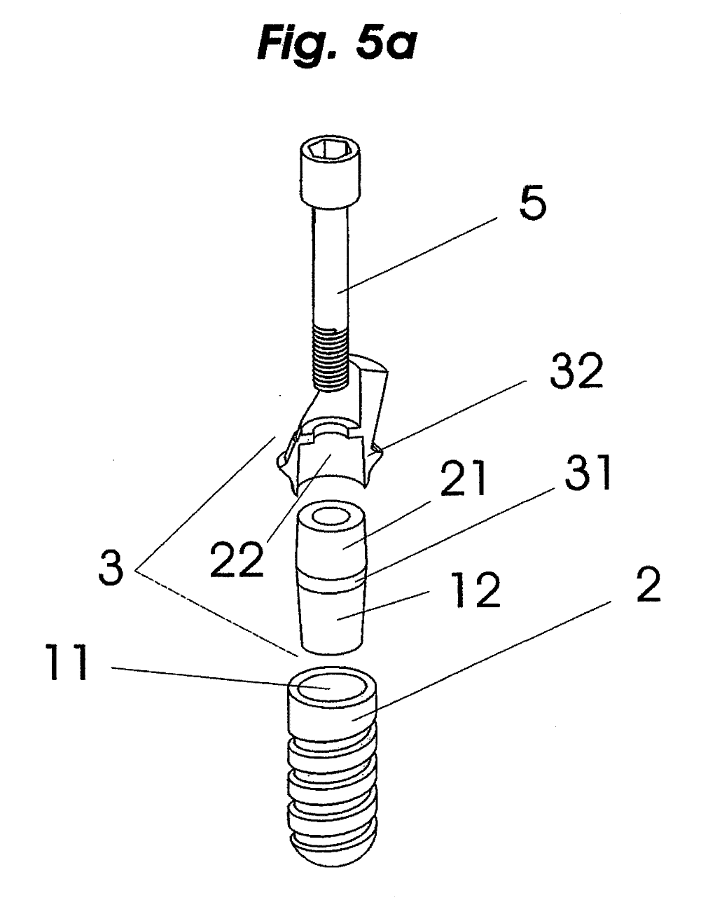

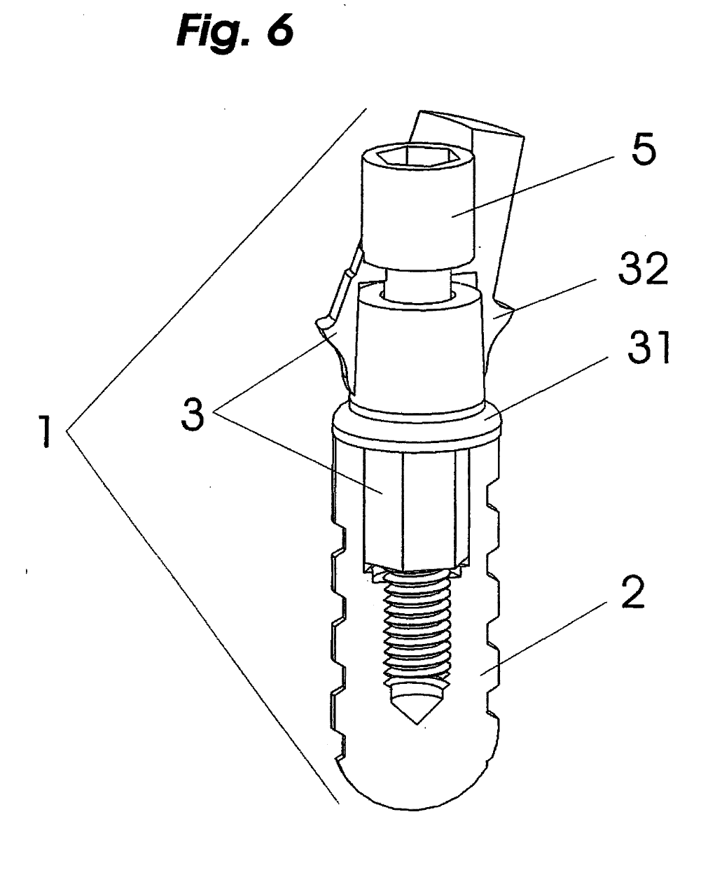

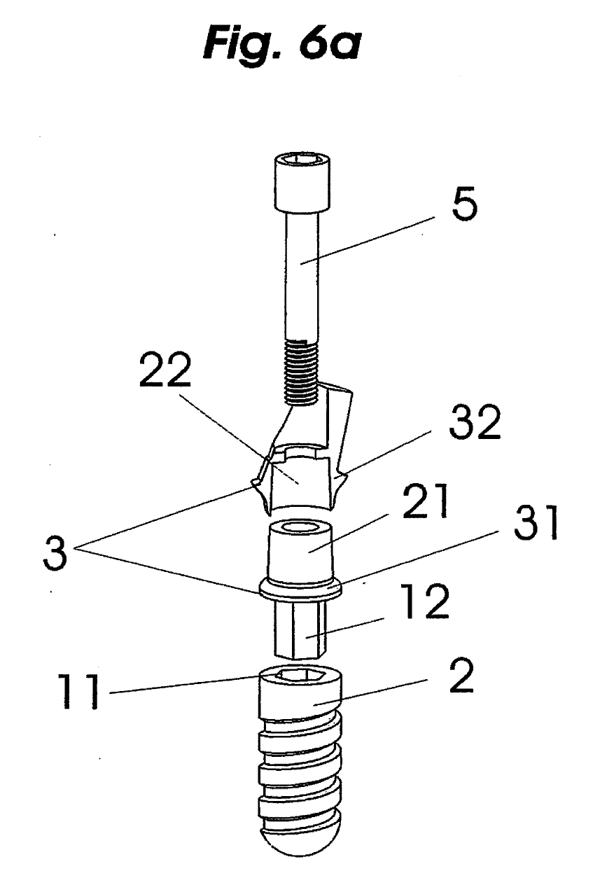

Moreover, all conceivable combinations of fixations 1-8 are possible. Consequently, a dental implant structured according to the invention without the crown or similar prosthetic tooth replacement consists of at least three parts in addition to a connection screw, if necessary. If no connection screw is present, the individual elements of the dental implant are connected to each other by means of a locking, blocking, adhering, cementing, welded, or soldered effect. The connection screw can assume the form as shown in FIG. 5-FIG. 6a. Other variations can be described as follows:
i. The pilot hole of the multiple-part mounting component is set up dimensionally such that the screw shaft has play in the bore. The screw thread is designed to have a diameter which is greater than the bore in the multiple-part mounting component. This can be achieved by means of various methods. For example, a threaded bushing can be applied after the screw shaft is pushed through. The threaded bushing can be screwed, welded, soldered, adhered, riveted and/or clamped.
ii. The dimensionally same or similar thread is cut and/or formed in the pilot hole of the multiple-part mounting component as in the screw and/or the post section. The diameter of the screw shaft of the connection screw is reduced such that it is equal to or smaller than the thread core of the pilot hole of the multiple-part mounting component.

One sample embodiment of the invention is explained in further detail on the basis of FIG. 5. FIG. 5 shows the structure of a dental implant according to the present invention, hereinafter designated as Variant 1. In FIG. 5, a dental implant 1 consisting of a post section 2, a two-part mounting component 3 and a connection screw 5 can be seen. The two-part mounting component 3 is subdivided into the implant-side/post section-side/first/lower mounted section 31 and the occlusal/second/upper mounted section. FIG. 5a shows an exploded view of the dental implant from FIG. 5. The contact pin 21 of the first/lower mounted section permits rotational movability of 360° about the axis of the first/lower mounted section upon contact with the recess 22. During the joining process of the two mounted sections 31 and 32 of the two-part mounting component, when a force is applied which tensions the two mounted sections, a locking effect, preferably a self-locking effect, occurs which permits a rotation of the two mounted sections relative to each other only with the application of increased force/torque. The elliptical and conical recess 11 of the post section 2 is structured such that it is positively and/or non-positively connected or mounted to the elliptical and conical contact pin 12 of the first/lower mounted section 31 of the mounting component 3. Upon connection/joining of the post section 2 with the mounting component 3 via the [sic] with or without the connection screw 5, a locking effect, preferably a self-locking effect, occurs over the elliptically shaped conical surfaces. The mounting component 3 is now rotationally secured against the post section 2. Indexing is achieved by way of the elliptical shape.

A further sample embodiment can be seen in FIG. 6. The dental implant 1 consists of a post section 2, the mounting component 3 and the connection screw 5. The mounting component 3 is subdivided into the first/lower mounted section 31 and the second/upper mounted section 32. During the process of joining the two mounted sections 31 and 32 of the two-part mounting component 3, when a force is applied which tensions the two mounted sections, a locking effect, preferably a self-locking effect, occurs which permits a rotation of the two mounted sections relative to each other only with the application of increased force/torque. FIG. 6a shows an exploded view of the dental implant from FIG. 6. The hexagon-shaped recess of the post section 2 is structured such that it can be positively and/or nonpositively connected with or mounted on the hexagon-shaped contact pin 12 of the first/lower mounted section 31 of the mounting component 3 and both mounted sections are rotationally secured against each other via the catch of the hexagon.

The invention is based on a mounting component with or without indexing in the direction of the post section being divided into at least two parts and the two or more mounting components being rotationally secured among each other prior to the final incorporation in the patient's mouth. The rotational securing can occur in the patient's mouth or on a plaster model but preferably prior to the preparation of the remaining prosthetic components.

Advantageously, contact with the implant occurs only with the implant-side part during the mechanical division of the mounting component. The second part advantageously has no mechanical coupling and no contact with the implant.

The multiple-part mounting component mounted in the patient's mouth and in use is not designed to be repeatedly removed at its internal connection. Neither of the at least two parts of the multiple-part mounting component is a removable element after incorporation in the patient's mouth.

The rotational movability of the multiple-part mounting component relative to each other should be more than 3°, advantageously more than 6° and particularly more than 10° and/or have more than 8, advantageously more than 12 and particularly more than 16 positioning possibilities.

The internal connection of the parts of the multiple-part mounting component can be structured conically, cylindrically, bluntly, with and without stop and with or without self-locking effect.

In the following, several variants of the coupling between implant and mounting component and the internal connection between the multiple-part, advantageously two-part mounting component are described.

### Variant 1

One variant of the rotational securing of the multiple-part mounting components is based on a self-locking mechanism, particularly a conical self-locking mechanism. When the two mounting components are joined, for example on a plaster model or in the patient's mouth, the dental technician or the person providing treatment can set the rotational position. Base[d] on the holding force of the self-locking mechanism, particularly of the conical self-locking mechanism, all other work can be undertaken without rotation occurring between the two mounting components.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable. When combining a basal conical self-locking mechanism and a conical self-locking mechanism in the direction occlusal to the basal part of the multiple-part mounting component, it proves advantageous to select a smaller cone angle in the conical self-locking mechanism in the occlusal direction than in the basal conical self-locking mechanism.

### Variant 2

Another variant of the rotational securing between the multiple-part mounting components is to produce either the matrix or the patrix of an indexing by the removal of metal. This can occur in combination with a self-locking mechanism, particularly a conical self-locking mechanism.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable.

### Variant 3

Another variant of the rotational securing between the multiple-part mounting components is to produce either the matrix or the patrix of an indexing by shaping. That is to say that the indexing through the plastic deformation of one or both mounting components or an auxiliary component.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable.

### Variant 4

Another variant of the rotational securing between the multiple-part mounting components is connecting through melting of one or both mounting components or of an auxiliary means. This can occur, for example, through soldering or welding.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable.

### Variant 5

Another variant of the rotational securing between the multiple-part mounting components is connecting through the introduction of an additive which hardens after the positioning of the mounting components and its introduction and preferably forms a compound with one or both mounting components.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable.

### Variant 6

Another variant of the rotational securing between the multiple-part mounting components is a geometric indexing with more than eight positioning possibilities (e.g. a triple square system) which is screwed.

The indexing of the basal mounting component in the direction of the implant can take on any geometric shape. The possibilities described above are advantageous. Particularly, one variant with a non-circular cone, for example an oval or an ellipse, which thus constitutes an indexing, is suitable.

Moreover, all possible combinations of the variations listed above are conceivable.

1. The dental implant as set forth in claim 2 wherein a post section is inserted into a jawbone and a mounting component is allocated to same onto which a dental prosthesis piece is mounted, wherein the mounting component is designed to be in multiple parts, preferably two parts, and comprises at least one first mounted section which can be joined with the dental prosthesis piece, wherein a second contact pin formed on the first mounted section is inserted into a designated recess in the second mounted section and the second is fixed to the first mounted section before the first contact pin formed on the first mounted section is inserted positively into a designated recess in the post section.

2. A dental implant comprising:
a post section which can be inserted into a jawbone; and
a mounting component allocated to same onto which a dental prosthesis piece can be mounted,
wherein the mounting component is comprised of multiple parts, preferably two parts, and in which a first mounted section with a first contact pin formed thereon can be inserted positively into a designated recess in the post section and a first mounted section with a second contact pin formed thereon can be inserted into a designated recess in the second mounted section, wherein the second contact pin formed on the first mounted section and the recess allocated to same are contoured in their cross sections such that the second contact pin inserted into the recess can be turned on its longitudinal axis about a twisting angle at least 3°, advantageously by at least 6°, especially advantageously at least 10° and on which the first contact pin formed on the first mounted section and the recess in the post section attached to same, each has an elliptical or oval cross section.

3. The dental implant as set forth in claim 2, in which the first mounted section, after insertion of the second contact pin into the designated recess of the second mounted section, can be tensioned with same.

4. The dental implant as set forth in claim 2, in which the mounted sections are mounted on the post section via a common connection screw.

5. The dental implant as set forth in claim 2, the recess of which provided in the post section and/or in the second mounted section has at least a nine-fold, preferably an at least thirteen-fold, particularly an at least seventeen-fold symmetry.

6. The dental implant as set forth in claim 2 in which, in the mounted state, exclusively the implant-side portion of the first mounted section is in mechanical connection or contact with the post section.

7. The dental implant as set forth in claim 2, the second mounted section of which has a positional marking for the identification of a provided orientation relative to the first mounted section.

8. The dental implant as set forth in claim 7, in which the positional marking is applied by splint-removing, shaping, particularly plastic shaping, by means of a laser or based on another shaping and/or removing and/or applying technique.

9. The dental implant as set forth in claim 2, in which the connection of the mounted sections with each other established via contact pin and recess has a locking and/or a self-locking, preferably a conically self-locking effect.

10. The dental implant as set forth in claim 2, in which the recess in the second mounted section is conical.

11. The dental implant as set forth in claim 2, in which the first mounted section is welded, soldered, adhered or positively connected with the second mounted section.

12. The dental implant as set forth in claim 3, in which the mounted sections are mounted on the post section via a common connection screw.

13. The dental implant as set forth in claim 3, the recess of which provided in the post section and/or in the second mounted section has at least a nine-fold, preferably an at least thirteen-fold, particularly an at least seventeen-fold symmetry.

14. The dental implant as set forth in claim 3, in which, in the mounted state, exclusively the implant-side portion of the first mounted section is in mechanical connection or contact with the post section.

15. The dental implant as set forth in claim 3, the second mounted section of which has a positional marking for the identification of a provided orientation relative to the first mounted section.

16. The dental implant as set forth in claim 15, in which the positional marking is applied by splint-removing, shaping, particularly plastic shaping, by means of a laser or based on another shaping and/or removing and/or applying technique.

17. The dental implant as set forth in claim 3, in which the connection of the mounted sections with each other established via contact pin and recess has a locking and/or a self-locking, preferably a conically self-locking effect.

18. The dental implant as set forth in claim 3, in which the recess in the second mounted section is conical.

19. The dental implant as set forth in claim 3, in which the first mounted section is welded, soldered, adhered or positively connected with the second mounted section.

20. The dental implant as set forth in claim 4, in which the first mounted section is welded, soldered, adhered or positively connected with the second mounted section.
